(19) United States
(12) Patent Application Publication
(10) Pub. No.: US 2016/0156767 A1
(43) Pub. Date: Jun. 2, 2016

(54) Methods and Devices to Provide Smart and Efficient Electrical and Electronic Systems

(71) Applicant: Iman Rezanezhad Gatabi, Sunnyvale, CA (US)

(72) Inventor: Iman Rezanezhad Gatabi, Sunnyvale, CA (US)

(21) Appl. No.: 14/941,659

(22) Filed: Nov. 15, 2015

Related U.S. Application Data
(60) Provisional application No. 62/086,221, filed on Dec. 2, 2014.
(60) Provisional application No. 62/152,026, filed on Apr. 23, 2015.

(51) Int. Cl. H04M 1/725

(52) U.S. Cl. CPC H04M 1/72533

(57) ABSTRACT

This application discloses methods and devices which may provide for smart and more efficient electrical and electronic systems. Implementation of smartphones and tablets to control some electrical or electronic systems are described. These may enhance the performance of the involved systems which may provide for a better marketing. In addition, methods are presented which may be applied to enhance the efficiencies of electrical or electronic devices or accessories of smartphones and tablets.

### CROSS-REFERENCE TO RELATED APPLICATIONS

This application claims the benefits of U.S. provisional application No. 62/086,221, filed on Dec. 2, 2014 and U.S. provisional application No. 62/152,026, filed on Apr. 23, 2015.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Smartphones and tablets are getting more and more popular nowadays. Using smartphones and tablets to control electrical and electronic systems is exceedingly important for providing smart and efficient systems. By implementing smartphones and tablets, a faster and more convenient control of electrical or electronic systems with an enhanced efficiency may be achieved. Moreover, improving the efficiency and performance of the accessories of smartphone and tablets are critical for an enhanced and more convenient use of smartphones and tablets.

### BRIEF SUMMARY OF THE INVENTION

Methods and devices are presented herein which may provide for smart and more efficient electrical and electronic systems. Implementation of smartphones and tablets to control some electrical or electronic systems will be described. These may enhance the performance of the involved systems which may provide for a better marketing. Moreover, methods will be presented which may be applied to enhance the efficiencies of electrical or electronic devices or accessories of smartphones and tablets.

### BRIEF DESCRIPTION OF THE SEVERAL VIEWS OF THE DRAWING

FIG. 1 shows a prior art related to the first aspect of the invention where it depicts a peephole camera which is mounted on a door through a hole from one side of the said door to its other side.

FIG. 2 shows a prior art related to the first aspect of the invention where it depicts a camera which has fixtures allowing it to be mounted on a wall.

FIG. 3 shows an example embodiment of implementation of the first aspect of the invention where it depicts an electronic device comprising of a camera, said device has a fixture or fixtures allowing it to be mounted on a door through a hole from one side of the said door to its other side, wherein the said hole has a diameter of at least 0.5 cm, wherein the said device sends a live view or a picture captured by the said camera to a smartphone, or a tablet or a computer.

FIG. 4 shows a prior art related to the first aspect of the invention where it depicts a method to provide a live view form back of a car.

FIG. 5 shows an example embodiment of implementation of the second aspect of the invention where it depicts a method to provide a live view form back of a car.

FIG. 6 shows a prior art related to the third aspect of the invention where it depicts a remote laser presenter along with a USB compatible device to communicate to a Personal Computer (PC).

FIG. 7 shows an example embodiment of implementation of the third aspect of the invention.

FIG. 8 illustrates a method to perform a presentation by using the device 1 as shown in FIG. 7.

FIG. 9 shows an example embodiment of implementation of the fourth aspect of the invention where it depicts a USB connector attached to a smartphone.

FIG. 10 shows an example embodiment of implementation of the fourth aspect of the invention where it depicts a handsfree attached to a smartphone, wherein a cable reel is placed inside the said smartphone.

FIG. 11 shows an example embodiment of implementation of the fourth aspect of the invention where it depicts the front view of a smartphone protective cover, wherein a USB connector is attached to the said cover through a cable.

FIG. 12 shows an example embodiment of implementation of the fourth aspect of the invention where it depicts the front view of a smartphone protective cover, wherein a handsfree is attached to the said cover.

FIG. 13 shows a prior art related to the fifth aspect of the invention where it depicts an electric power plug mounted on a wall.

FIG. 14 shows a prior art related to the fifth aspect of the invention where it depicts an electric wall switch in order to turn ON or OFF a lamp.

FIG. 15 shows an example embodiment of implementation of the fifth aspect of the invention where it depicts a smartphone charger with a light source.

FIG. 16 shows an example embodiment of implementation of the fifth aspect of the invention where it depicts a flash memory stick with a LED.

FIG. 17 shows an example embodiment of implementation of the fifth aspect of the invention where it depicts a TV set wherein the plug of its power cord has an LED.

FIG. 18 shows an example embodiment of implementation of the fifth aspect of the invention where it depicts a smartphone to USB adapter wherein a first LED is implemented in the USB connector in one end of the cable of the said adapter and a second LED is implemented in the smartphone connector in the other end of the said cable.

FIG. 19 shows an electronic circuit that can be used to implement the fifth aspect of the invention.

FIG. 20 shows a prior art related to the sixth aspect of the invention where it depicts a method to turn ON or OFF a lamp operating with mains electricity which is implemented in the roof of a room.

FIG. 21 shows an example embodiment of implementation of the sixth aspect of the invention where it depicts a method to turn ON or OFF a lamp operating with mains electricity which is implemented in the roof of a room.

FIG. 22 shows an example embodiment of implementation of the sixth aspect of the invention where it depicts a method to turn ON or OFF a lamp operating with mains electricity which is implemented in the roof of a room.

FIG. 23 shows an example embodiment of implementation of the sixth aspect of the invention where it depicts a method to turn ON or OFF a lamp operating with mains electricity which is implemented in the roof of a room.

FIG. 24 shows an example embodiment of implementation of the sixth aspect of the invention where it depicts a method to turn ON or OFF a lamp operating with mains electricity which is implemented in the roof of a room.

FIG. 25 shows an example embodiment of implementation of the sixth aspect of the invention where it depicts a method to turn ON or OFF two lamps operating with mains electricity which are implemented in the roof of a room.

FIG. 26 shows an example embodiment of implementation of the sixth aspect of the invention where it depicts a method to turn ON or OFF a lamp operating with mains electricity which is implemented in the roof of a room.

### DETAILED DESCRIPTION OF THE INVENTION

Different examples will be described in details that represent some example embodiments of the presented methods or devices. However the technical and structural descriptions presented herein are representative for the purposes of describing the presented methods or devices, the described methods or devices may be embodied in many alternate forms and should not be limited to the example embodiments described herein.

The described examples can be modified in various alternative forms. For example, the thickness and dimensions of the regions in drawings may be exaggerated for clarity. There is no intention to limit the methods or devices to the particular forms disclosed. However, examples are used to describe the methods or devices and to cover some modifications and alternatives within the scopes of the invention.

The spatially relative terms used here such as “underneath”, “below” and “above” are for the ease of description and to show the relationship between an element and another one in the figures. If the device in the figure is turned over, elements described as “underneath” or “below” other elements would then be “above” other elements. Therefore, for example, the term “underneath” can represent an orientation which is below as well as above. If the device is rotated, the spatially relative terms used herein should be interpreted accordingly.

Unless otherwise stated, variations of the shapes of the figures as a result of, for example, manufacturing techniques and tolerances are expected. Therefore, the regions illustrated in figures are schematic and their shapes do not necessarily show the actual shape of the fabricated device. Unless otherwise stated, there is no intention to limit the invention to the values (such as dimensions and voltages) used to describe the example embodiments. These values are selected to describe the related characteristics for a better understanding of the presented methods or devices. Unless otherwise stated, the terms used herein have the same meaning as commonly understood by someone with ordinary skills in the invention field.

Throughout this document, the whole device structure or the entire systems in provided example embodiments may not be presented for the sake of simplicity. This can be understood by someone with ordinary expertise in the field of invention. For example, when showing a smartphone, we may just show the display and the main button of the smartphone and not the ON/OFF and volume buttons. In such cases, any new or well-known designs for the un-shown parts are expected. Therefore, it should be understood that the provided example embodiments may just have illustrations that are mainly intended to show the scope of the invention and different designs of other parts of the device are expected.

The first aspect of this invention describes an electrical or electronic device comprising of a camera, said device has a fixture or fixtures allowing the said device to be attached to a peephole lens or to be mounted on a door through a hole from one side of the said door to its other side, wherein the said hole has a diameter of at least 0.5 cm, wherein the said device sends a live view or a picture captured by the said camera to a second electrical or electronic device, wherein the said live view or picture is displayed in a smartphone, or a tablet or a computer. In some example embodiments, the said second electrical or electronic device is the said smartphone, or the said tablet, or the said computer. In other example embodiments, the said device that has a camera may further comprise of a button or a touch sensor, wherein pressing the said button or touching the said sensor provides a signal to cause a ring, or a beep, or a music, or a vibration, or a noise in the said device that has a camera or another electrical or electronic device. In some example embodiments, the said device that has a camera may further comprise of a motion detector sensor or a vibration sensor. In an example embodiment, a vibration of the said device that has a camera provides a signal to cause a ring, or a beep, or a music, or a vibration, or a noise in the said device that has a camera or another electrical or electronic device.

Prior arts in this field include peephole cameras that have fixtures allowing them to be mounted on a door through a hole from one side of the said door to its other side. Some of these peephole cameras has a monitor attached to them which may display a live view of the outside captured by the said camera. However, non of the said prior arts sends a live view or a picture to a second electrical or electronic device, wherein the said live view or picture is displayed in a smartphone, or a tablet or a computer. Some prior arts which send a live view or a picture to a second electrical or electronic device, wherein the said live view or picture is displayed in a smartphone, or a tablet or a computer, have fixtures allowing the device to be mounted on a wall. They do not have fixtures allowing them to be attached to a peephole lens or to be mounted on a door through a hole from one side of the said door to its other side.

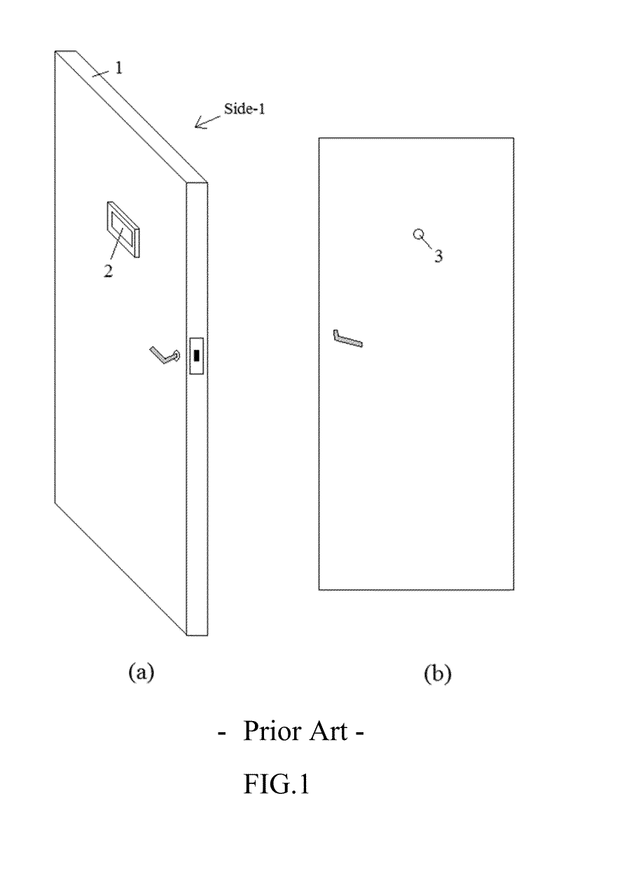

FIG. 1 shows a prior art related to the first aspect of the invention where it depicts a peephole camera which is mounted on a door through a hole from one side of the said door to its other side. FIG. 1.b is a view of FIG. 1.a from side-1. Here, 1 is a door, 2 is a monitor and 3 is a lens behind which there is a CCD of a camera (not shown in this picture). In this prior art, a live view captured by the said camera if displayed on the monitor 2. This prior art does not send a live view or a picture captured by the said camera to a second electrical or electronic device, wherein the said live view or picture is displayed in a smartphone, or a tablet or a computer.

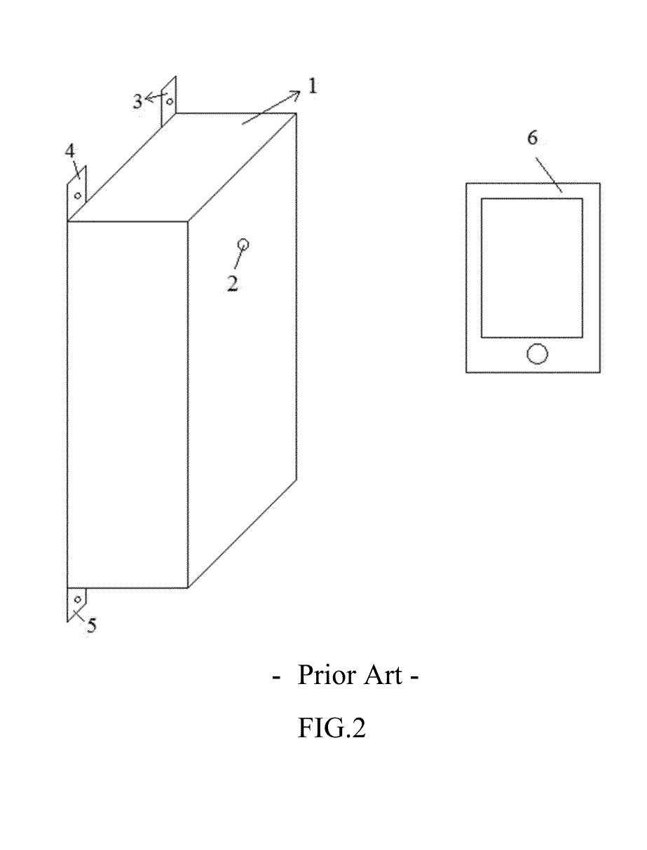

FIG. 2 shows a prior art related to the first aspect of the invention where it depicts a camera which has fixtures allowing it to be mounted on a wall. In this figure, 1 is a case for the said camera, 2 is a lens behind which is the said camera, 3, 4 and 5 are plates with holes which can be used to mount the case 1 on a wall with screws, and 6 is a smartphone. The said camera sends a live view to the smartphone 6 through WiFi or Bluetooth connection. The case 1 does not have a fixture or fixtures allowing it to be attached to a peephole lens or to be mounted on a door through a hole from one side of the said door to its other side, the said hole has a diameter of at least 0.5 cm.

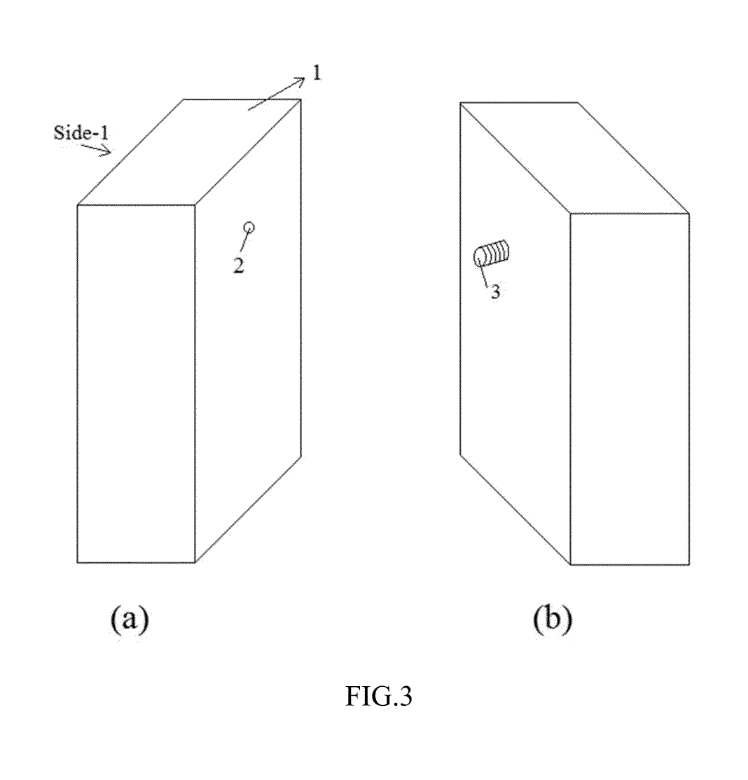

FIG. 3 shows an example embodiment of implementation of the first aspect of the invention where it depicts an electronic device 1 comprising of a camera (which is inside the case of the device 1 that is not shown in the figure), said device has a fixture or fixtures 3 allowing it to be mounted on a door through a hole from one side of the said door to its other side, wherein the said hole has a diameter of at least 0.5 cm, wherein the said device sends a live view or a picture captured by the said camera to a smartphone, or a tablet or a computer. FIG. 3.b is a view of FIG. 3.a from side-1. In this figure, 2 is a lens behind which the said camera is located inside the case of device 1 and 3 is a screw mounted on the case of device 1. The device 1 may send a live view or a picture captured by the said camera to the said smartphone, or tablet or computer through any communication protocol such as WiFi or Bluetooth. In order to mount the device 1 on a door through a hole from one side of the said door to its other side, wherein the said hole has a diameter of at least 0.5 cm, device 1 may be placed on one side of the said door wherein screw 3 goes inside the said hole and a part of screw 3 comes out of the said hole from the other side of the said door. A nut may be attached to the said part of the screw 3 that comes out from the other side of the said door to fix the device 1 to the said door. In some example embodiments, device 1 further comprises of a button or a touch sensor, wherein pressing the said button or touching the said sensor provides a signal to cause a ring, or a beep, or a music, or a vibration, or a noise in device 1 or another electrical or electronic device. In other example embodiments, device 1 further comprises of a vibration sensor, wherein a vibration of device 1 (which may be caused due to knocking the door on which device 1 is mounted on) provides a signal to cause a ring, or a beep, or a music, or a vibration, or a noise in the said device or another electrical or electronic device. In other example embodiments, device 1 further comprises of a motion detector sensor, wherein a motion in a live view captured by the said camera provides a signal to cause a ring, or a beep, or a music, or a vibration, or a noise in the said device or another electrical or electronic device.

The second aspect of this invention describes a method to provide a live view form back of a car, said method comprises of implementation of a first electrical or electronic device, wherein the said first device comprises of a camera, wherein the said first device sends a live view captured by the said camera to a second electrical or electronic device, wherein the said live view is displayed by a smartphone, or a tablet, wherein at least two lines are displayed on the said live view by the said smartphone or tablet, wherein an approximate future location of the said car may lie between the said lines, should the said car move backward. In some example embodiments, the said second electrical or electronic device is the said smartphone, or the said tablet. In other example embodiments, the positions of the said lines in the display of the said smartphone or tablet can be adjusted.

Prior arts in this field include a method comprising of implementation of a first electrical or electronic device, wherein the said first electrical or electronic device comprises of a camera, wherein the said first electrical or electronic device sends a live view captured by the said camera to a second electrical or electronic device, wherein the said live view is displayed by a display on the dashboard of a car, wherein at least two lines are displayed on the said live view by the said display, wherein an approximate future location of the said car may lie between the said lines, should the said car move backward. In non of these prior arts, the said live view captured by the said camera is displayed by a smartphone, or a tablet.

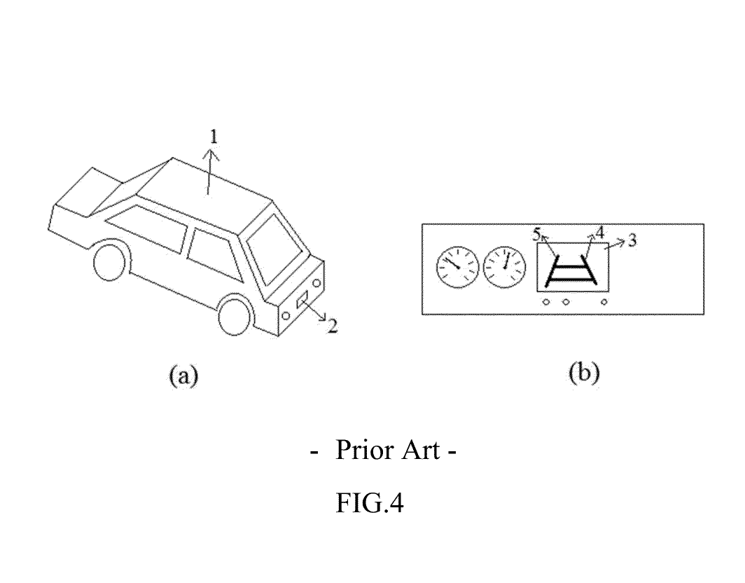

FIG. 4 shows a prior art related to the second aspect of the invention where it depicts a method to provide a live view form back of a car 1, said method comprises of implementation of a first electrical or electronic device 2, wherein the said first device comprises of a camera (not shown in this figure), wherein the said first device sends a live view captured by the said camera to a second electrical or electronic device, wherein the said live view is displayed by a display 3 on the dashboard of the said car 1, wherein at least two lines (4 and 5) are displayed by the said display 3 on the said smartphone, wherein an approximate future location of the said car may lie between the said lines, should the said car move backward. In this illustration, FIG. 4.b shows the dashboard of the car 1 shown in FIG. 4.a.

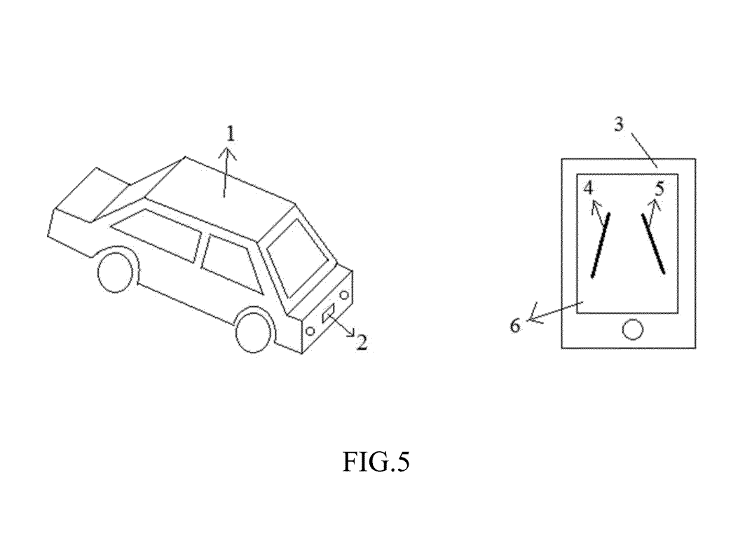

FIG. 5 shows an example embodiment of implementation of the second aspect of the invention where it depicts a method to provide a live view form back of a car 1. Said method comprises of implementation of a first electrical or electronic device 2, wherein the said first device comprises of a camera (not shown in this figure), wherein the said first device sends a live view captured by the said camera to a second electrical or electronic device (smartphone 3 in this example embodiment), wherein the said live view is displayed by a smartphone 3, wherein at least two lines are displayed on the said live view by the said smartphone (4 and 5), wherein an approximate future location of the said car may lie between the said lines, should the said car move backward. Here, 6 is a display of smartphone 3. In some example embodiments, the positions of lines 4 and 5 in the display 6 of the said smartphone 3 can be adjusted.

The third aspect of this invention describes an electronic device comprising of a laser light source, said device has a first button or touch sensor and a second button or touch sensor, wherein pressing the said button or buttons or touching the said sensor or sensors causes pages of a presentation slide file in a smartphone to turn, wherein by pressing the said first button or touching the said first touch sensor, the current page of the said presentation file is turned to a next page, wherein by pressing the said second button or touching the said second touch sensor, the current page of the said presentation file is turned to a previous page. In some example embodiments, the said electronic device further comprises of a third button or touch sensor, wherein pressing the said third button or touching the said third sensor turns ON the said laser light source. A method may be implemented to perform a presentation by using the said device, said method comprises of connecting the said smartphone to a projector or a monitor using an adapter, wherein the slides or pages of the said presentation file is displayed on the said monitor or is projected by the said projector.

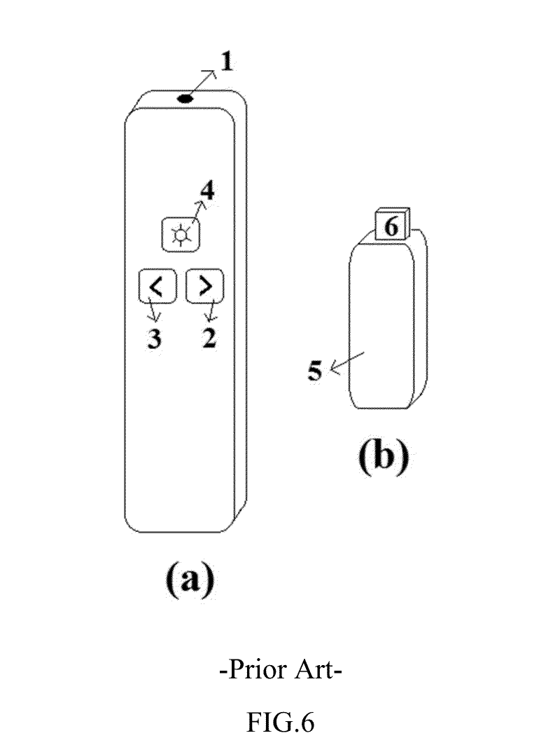

FIG. 6 shows a prior art related to the third aspect of the invention where it depicts a remote laser presenter along with a USB compatible device 5 to communicate to a Personal Computer (PC). In this illustration, FIG. 6.a shows a remote laser presenter comprising of a laser light source 1, said laser presenter has a first button 2 and a second button 3, wherein pressing the said buttons causes pages of a presentation slide file in a Personal Computer (PC) to turn, wherein by pressing the said first button 2, the current page of the said presentation file is turned to a next page, wherein by pressing the said second button 3, the current page of the said presentation file is turned to a previous page. Here, pressing button 4 turns ON the said laser light source 1. FIG. 6.b illustrates a USB compatible device 5 which can be connected to a PC through a USB port, said USB compatible device may send or receive signals to or from the said remote laser presenter in order to turn the pages of the said presentation file in the said PC. Here, 6 is a USB connector.

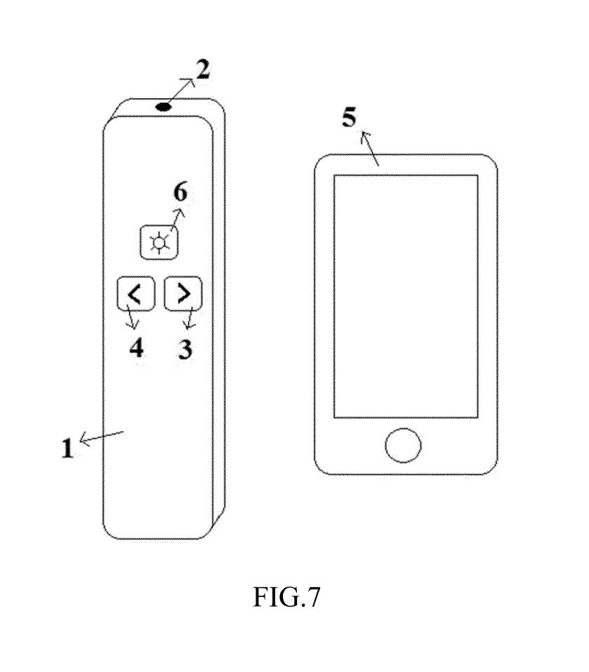

FIG. 7 shows an example embodiment of implementation of the third aspect of the invention where it depicts an electronic device 1 comprising of a laser light source 2, said device 1 has a first button 3 and a second button 4, wherein pressing the said buttons (3 and 4) causes pages of a presentation slide file in a smartphone 5 to turn, wherein by pressing the said first button 3, the current page of the said presentation file is turned to a next page, wherein by pressing the said second button 4, the current page of the said presentation file is turned to a previous page. In this example embodiment, the said electronic device 1 comprises of a third button 6, wherein pressing the said third button 6 turns ON the said laser light source 2. Device 1 may communicate to the smartphone 5 through any communication protocol such as WiFi or Bluetooth.

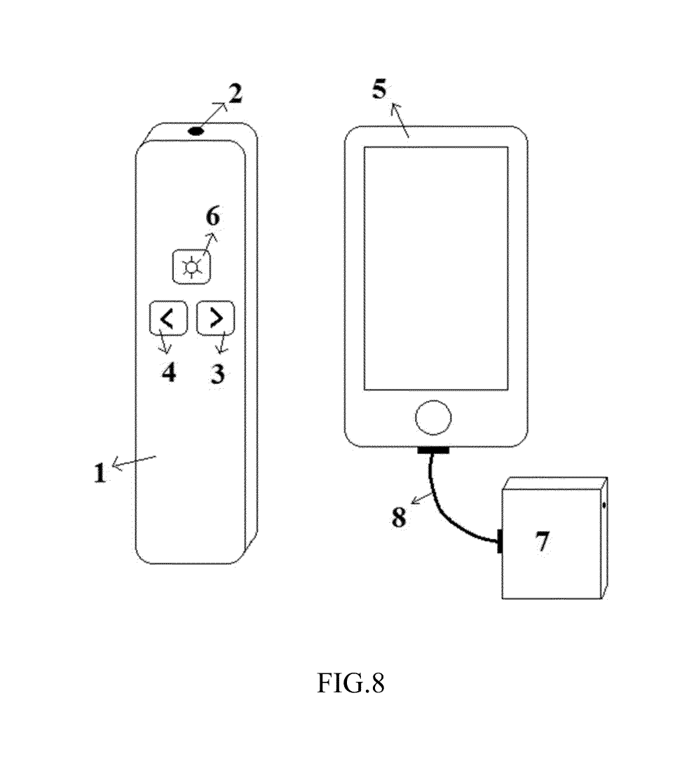

FIG. 8 illustrates a method to perform a presentation by using the device 1 as shown in FIG. 7, said method comprises of connecting the said smartphone 5 to a projector 7 using an adapter 8, wherein by pressing the said first button 3, the current page of the said presentation file is turned to a next page, wherein by pressing the said second button 4, the current page of the said presentation file is turned to a previous page, wherein the slides or pages of the said presentation file is projected by the said projector 7. Adapter 8 may be a smartphone to VGA adapter or a smartphone to HDMI adapter.

The fourth aspect of this invention describes a method to attach a handsfree or an earphone or a USB connector to a smartphone or a smartphone protective cover, said method comprises of physically connecting a cable of the said handsfree or the said earphone or the said USB connector to a part of the said smartphone or cover, wherein a part of the cable of the said handsfree or earphone or USB connector can go inside or come out of the case of the said smartphone or the said cover. In some example embodiments where the said handsfree or earphone or USB connector is attached to a smartphone protective cover, a smartphone may be placed inside the said cover, wherein the said cover has an electronic connector or adapter, wherein the said handsfree or earphone or USB connector is electrically or electronically connected to the said smartphone through the said electronic connector or adapter.

In a conventional method, in order to use a hansfree or an earphone or a USB connector with a smartphone, one should carry the said handsfree or earphone or USB connector separate from the said smartphone and hook them up to the smartphone when needed. Some example embodiments of the fourth aspect of this invention, allows the attachment of a handsfree or an earphone or a USB connector to a smartphone or a smartphone cover. Therefore, the said handsfree or earphone or USB connectro do not need to be carried separate from the smartphone.

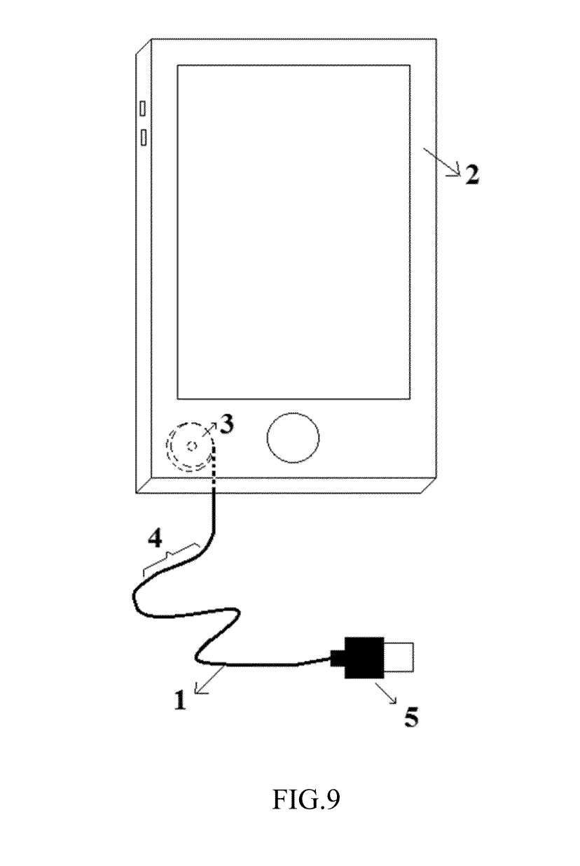

FIG. 9 shows an example embodiment of implementation of the fourth aspect of the invention where it depicts a USB connector 5 attached to a smartphone 2, wherein a cable reel 3 is placed inside the said smartphone 2. In this example embodiment, a part 4 of cable 1 of the said USB connector can go inside or come out of the case of the said smartphone 2, and a part 4 of the cable 1 can be wrapped around the reel 3. In this example embodiment, portions that are inside the case of smartphone 2 are shown with dashed lines. In some example embodiments, a spring can be attached to the reel 3, wherein a pulling of connector 5 causes a part of the cable 1 to come out of the case of smartphone 2, wherein a pulling and releasing of the connector 5 causes a part of cable 1 to go inside the case of smartphone 2.

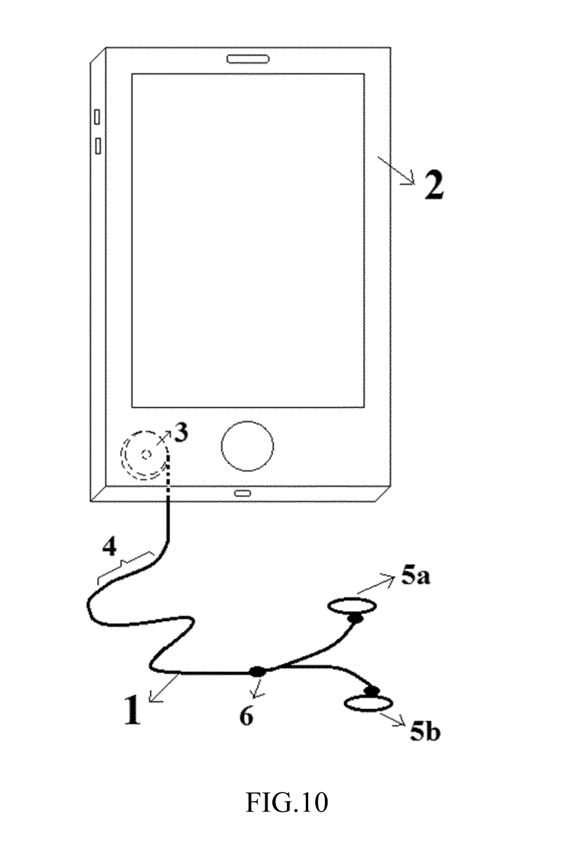

FIG. 10 shows an example embodiment of implementation of the fourth aspect of the invention where it depicts a handsfree attached to a smartphone 2, wherein a cable reel 3 is placed inside the said smartphone 2. Here, 5a and 5b are earphones of the said handsfree and 6 is the microphone of the said handsfree. In this example embodiment, a part 4 of cable 1 can go inside or come out of the case of the said smartphone 2, and a part 4 of the cable 1 can be wrapped around the reel 3. In this example embodiment, portions that are inside the case of smartphone 2 are shown with dashed lines. In some example embodiments, a spring can be attached to the reel 3, wherein a pulling of cable 1 causes a part of the cable 1 to come out of the case of smartphone 2, wherein a pulling and releasing of the cable 1 causes a part of cable 1 to go inside the case of smartphone 2.

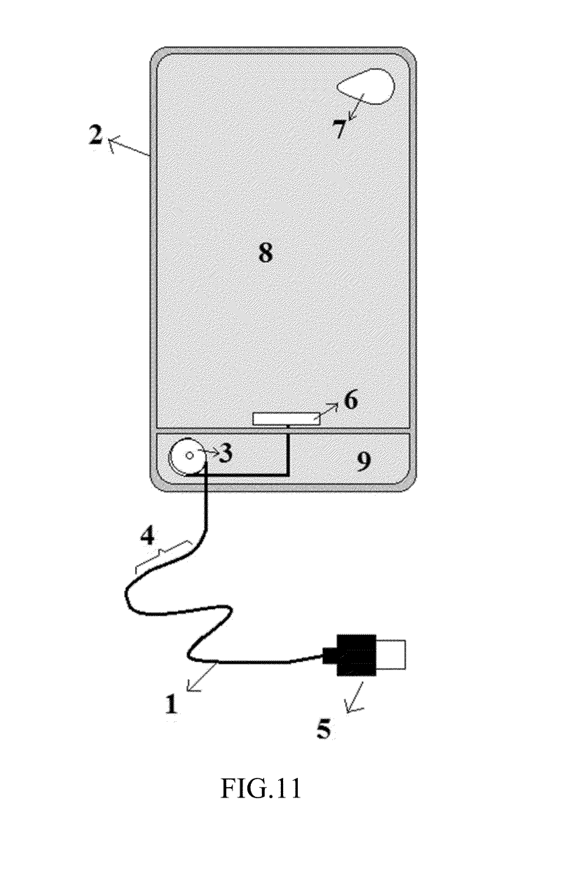

FIG. 11 shows an example embodiment of implementation of the fourth aspect of the invention where it depicts the front view of a smartphone protective cover 2, wherein a USB connector 5 is attached to the cover 2 through a cable 1, wherein a cable reel 3 is placed inside the said smartphone protective cover 2. In this example embodiment, a part 4 of cable 1 of the said USB connector can go inside or come out of the said smartphone protective cover 2, and a part 4 of the cable 1 can be wrapped around the reel 3. One end of cable 1 is connected to the USB connector 5 and the other end of cable 1 is connected to an electronic connector 6. In the case that a smartphone is placed inside the cover 2, the USB connector 5 is electrically or electronically connected to the said smartphone through the connector 6. Here, the said cover 2 is divided into two portions (8 and 9) wherein the said smartphone is placed inside portion 8. In this example embodiment, 7 is an opening in cover 2 which lies below the lens and flash light of the said smartphone when the said smartphone is placed inside the cover 2. In some example embodiments, a spring can be attached to reel 3, wherein a pulling of connector 5 causes a part 4 of the cable 1 to come out of the case of smartphone 2, wherein a pulling and releasing of the connector 5 causes a part 4 of cable 1 to go inside the case of smartphone 2.

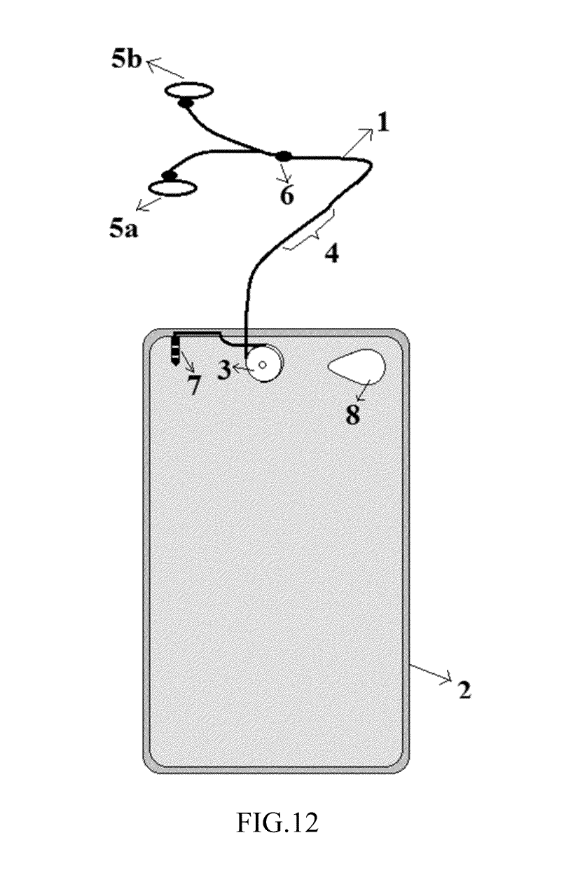

FIG. 12 shows an example embodiment of implementation of the fourth aspect of the invention where it depicts the front view of a smartphone protective cover 2, wherein a handsfree is attached to the cover 2, wherein a cable reel 3 is placed inside the said smartphone protective cover 2. In this example embodiment, a part 4 of cable 1 of the said handsfree can go inside or come out of the said smartphone protective cover 2, and a part 4 of the cable 1 can be wrapped around the reel 3. One end of cable 1 is connected to an electronic connector 7. In the case that a smartphone is placed inside the cover 2, the said handsfree is electrically or electronically connected to the said smartphone through the connector 7. Here, the reel 3 will be between the said smartphone and the cover 2 when the said smartphone is placed inside cover 2. In this example embodiment, 8 is an opening in the cover 2 which lies below the lens and flash light of the said smartphone when the said smartphone is placed inside cover 2. In this example embodiment, 5a and 5b are earphones of the said handsfree and 6 is the microphone of the said handsfree. In some example embodiments, a spring can be attached to reel 3, wherein a pulling of cable 1 causes a part of the cable 1 to come out of the case of cover 2, wherein a pulling and releasing of cable 1 causes a part of cable 1 to go inside cover 2.

The fifth aspect of this invention describes a method to implement a light source in a cable, or in an electrical or electric connector, or in an electrical or electric adapter, or in a charger, or in an electrical or electronic plug, said method comprises of implementation of a rechargeable electrical or electronic power source, wherein the said power source may provide a power to turn ON the said light source, wherein the said power source may charge up when the said cable, or connector, or adapter, or charger or plug is electrically or electronically connected to another electrical or electronic device, or another cable, or another connector, or another adapter, or another plug or a mains power.

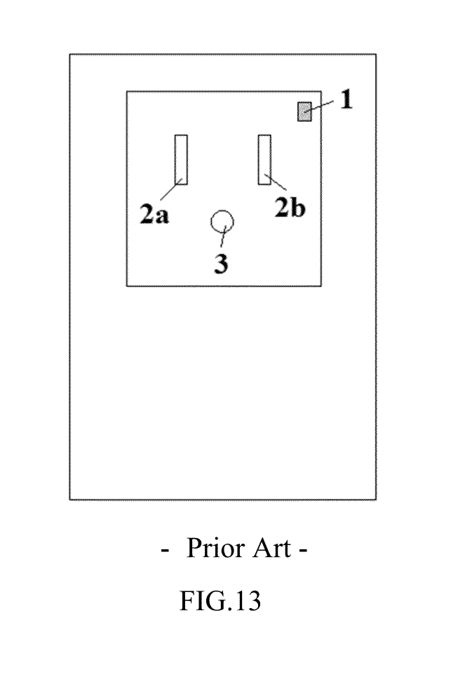

FIG. 13 shows a prior art related to the fifth aspect of the invention where it depicts an electric power plug mounted on a wall. Said power plug has a Light Emitting Diode (LED) 1, which is ON when there is not an electrical power outage. 2a and 2b are connectors to the mains electricity and 3 is the connector to earth ground. In this prior art, LED 1 may make the said power plug more visible in dark environments. However, LED 1 will turn OFF when there is an electrical power outage.

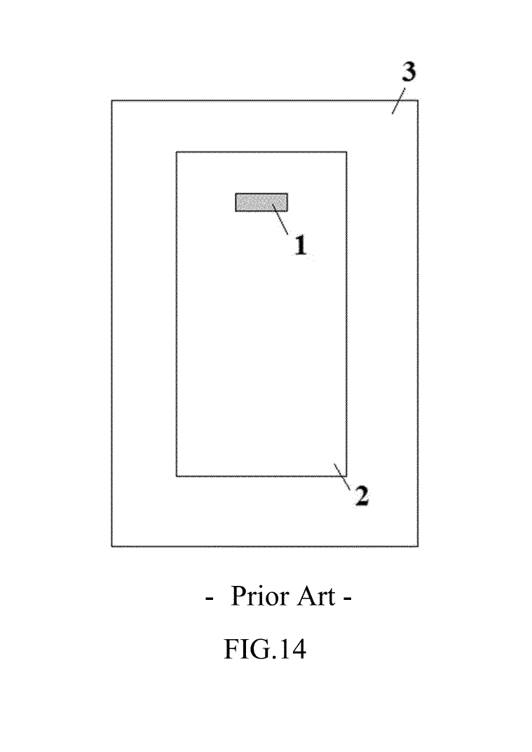

FIG. 14 shows a prior art related to the fifth aspect of the invention where it depicts an electric wall switch in order to turn ON or OFF a lamp. Said switch has a Light Emitting Diode (LED) 1, which is ON when there is not an electrical power outage. 2 is a button to turn ON and OFF the said lamp and 3 is the frame of the said electric wall switch. In this prior art, LED 1 may make the said switch more visible in dark environments. However, LED 1 will turn OFF when there is an electrical power outage.

Another prior art in this field is a power button on the case of a Personal Computer (PC) used to turn ON or OFF the said PC, wherein the said button has a LED wherein the said LED in ON when the power cord of the said PC is hooked up to an electric power plug and when there is not an electric power outage. In this prior art, said LED may make the said button more visible in dark environments. However, said LED will turn OFF the said PC is not hooked up to an electric power plug or when there is an electric power outage.

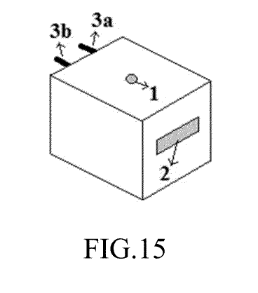

FIG. 15 shows an example embodiment of implementation of the fifth aspect of the invention where it depicts a smartphone charger comprising of a light source 1, said charger has a rechargeable battery (not shown in this picture), wherein the said battery provides a power to turn ON the said light source 1, wherein the said battery may charge up when the said charger is electrically connected to an electrical power outlet of a wall. Here, 2 is a USB connector and 3a and 3b are connectors to connect the said charger to an electrical power outlet of a wall. In this example embodiment, the light source 1 is ON even when the said charger is not plugged to an electrical power outlet of a wall until the said battery runs out of charge. In other example embodiments, when the said charger is not electrically connected to an electrical power plug of a wall, the light source 1 may flicker instead of being constantly ON. In other example embodiments, a capacitor or a super capacitor may be implemented instead of the said battery.

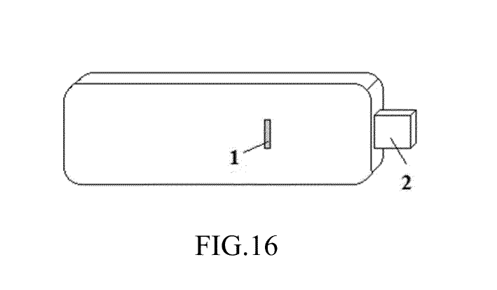

FIG. 16 shows an example embodiment of implementation of the fifth aspect of the invention where it depicts a flash memory stick comprising of a LED 1, said flash memory stick has a rechargeable battery (not shown in this picture), wherein the said battery provides a power to turn ON the said LED 1, wherein the said battery may charge up when the said flash memory stick is electronically connected to a USB connector of a computer. Here, 2 is a USB connector. In this example embodiment, the LED 1 is ON even when the said flash memory stick is not plugged to a USB connector of a computer until the said battery runs out of charge. In other example embodiments, when the said flash memory stick is not electronically connected to a USB connector of a computer, the LED 1 may flicker instead of being constantly ON. In other example embodiments, a capacitor or a super capacitor may be implemented instead of the said battery.

It should be mentioned that the said light source as described in the fifth aspect of invention may be any type of light source including (but not limited to), LED and lamps and it may have any shape or dimensions.

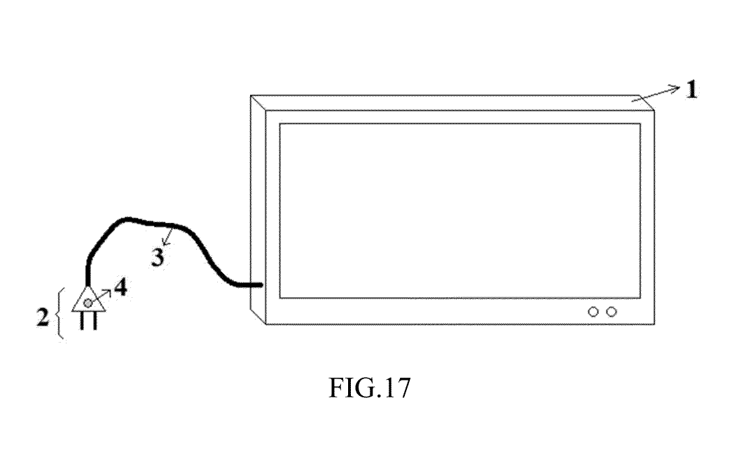

FIG. 17 shows another example embodiment of implementation of the fifth aspect of the invention where it depicts a TV set 1 wherein the plug 2 of its power cord 3 has an LED 4. A rechargeable battery (not shown in this picture) is implemented in the TV set 1 (or in the plug 2 in other example embodiments), wherein the said battery provides a power to turn ON the said LED 4, wherein the said battery may charge up when the said plug 2 connected to an electrical power outlet of a wall. In this example embodiment, the LED 4 is ON even when the said plug is not connected to an electrical power outlet of a wall until the said battery runs out of charge. In other example embodiments, when the said plug is not connected to an electrical power outlet of a wall, the LED 4 may flicker instead of being constantly ON. In other example embodiments, a capacitor or a super capacitor may be implemented instead of the said battery.

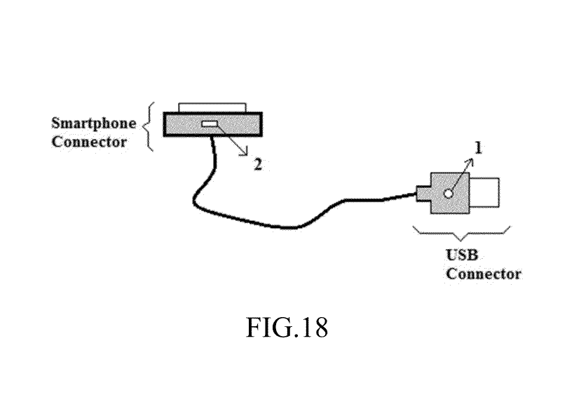

FIG. 18 shows another example embodiment of implementation of the fifth aspect of the invention where it depicts a smartphone to USB adapter wherein a first LED 1 is implemented in the USB connector in one end of the cable of the said adapter and a second LED 2 is implemented in the smartphone connector in the other end of the said cable. Said adapter comprises of a a rechargeable battery (not shown in this picture which can be implemented anywhere in the said cable or in the said connectors), wherein the said battery provides a power to turn ON the said LEDs (1 and 2), wherein the said battery may charge up either when the said adapter is electronically connected to a smartphone or whwn the said adapter is electronically connected to a USB connector of a computer or charger. In this example embodiment, the said LEDs (1 and 2) are ON even when the said adapter is not plugged to a USB connector of a computer or charger or even when it is not plugged to a smartphone, until the said battery runs out of charge.

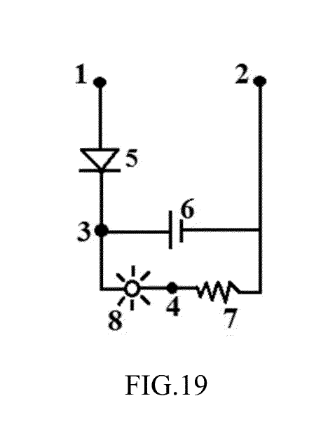

FIG. 19 shows an electronic circuit that can be used to implement the fifth aspect of the invention, said circuit has a first 1 and a second 2 and a third 3 and a fourth 4 electrical node, wherein the said first node is electrically connected to an anode of a diode 5, wherein the said second node 2 is electrically connected to a first electrical terminal of a rechargeable power source 6 and a first electrical terminal of a resistor 7, wherein the said third node is electrically connected a cathode of the said diode 5 and to a second electrical terminal of the said power source 6 and to a first electrical terminal of a light source 8, wherein the said fourth node is electrically connected to a second electrical terminal of the said light source 8 and to a second electrical terminal of the said resistor 7, wherein the said first and second nodes (1 and 2) can be electrically connected to the wires of a cable, or to electrical terminals of an electrical or electric connector, or to electrical terminals of an electrical or electric adapter, or to electrical terminals of a charger, or to electrical terminals of an electrical or electronic plug.

The sixth aspect of this invention describes a method to turn ON or OFF an electrical light source operating with mains electricity or household electricity, said method comprises of implementation of a first electrical or electronic system that provides a signal in the form of an ultrasonic or an electromagnetic wave, wherein the said signal is received by a second electrical or electronic system, wherein the ON or OFF status of the said light source may be changed if the magnitude of the said received signal is higher than a threshold value. In some example embodiments, the said first electrical or electronic system further comprises of a button or a touch sensor, wherein pressing the said button or touching the said sensor provides the said signal, wherein by pressing the said button or touching the said sensor, the ON or OFF status of the said light source is changed when the magnitude of the said received signal is larger than the said threshold value. The magnitude of the said received signal by the said second electrical or electronic system may be changed based on the spatial position of the said first electrical or electronic system, wherein for a first spatial position of the said first electrical or electronic system, the magnitude of the said received signal is larger than the said threshold value, wherein for a second spatial position of the said first electrical or electronic system, the magnitude of the said received signal is smaller than the said threshold value, wherein for the said first spatial position, the ON or OFF status of the said light source will be changed when the said signal is received by the said second electrical or electronic system, wherein for the said second spatial position, the ON or OFF status of the said light source is not changed when the said signal is received by the said second electrical or electronic system.

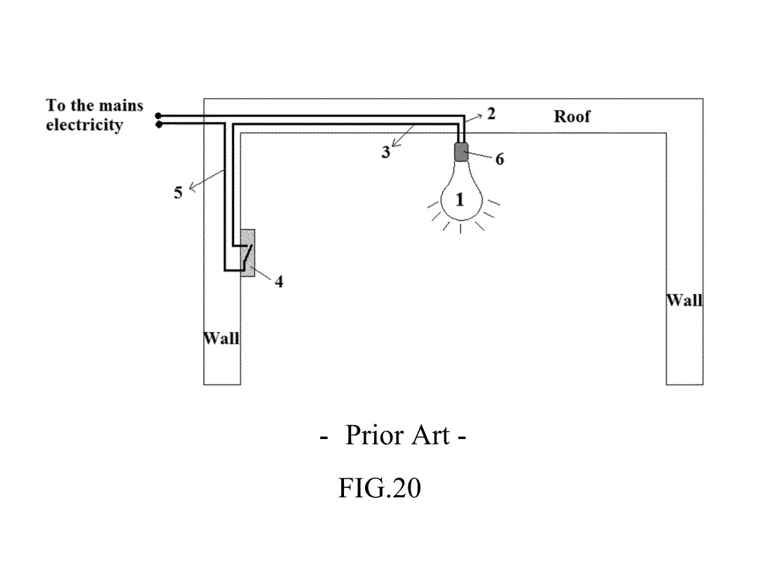

FIG. 20 shows a prior art related to the sixth aspect of the invention where it depicts a method to turn ON or OFF a lamp 1 operating with mains electricity which is implemented in the roof of a room. Here, lamp 1 is connected to a lamp socket 6, a wire 2 is connecting a first contact of the said lamp socket 6 to a first contact of the mains electricity, a wire 3 is connecting a second contact of the said lamp socket 6 to a first contact of an electrical key 4, and a wire 5 is connecting a second contact of the said key 4 to a second contact of the said mains electricity. Lamp 1 can be turned ON and OFF by the said key 4.

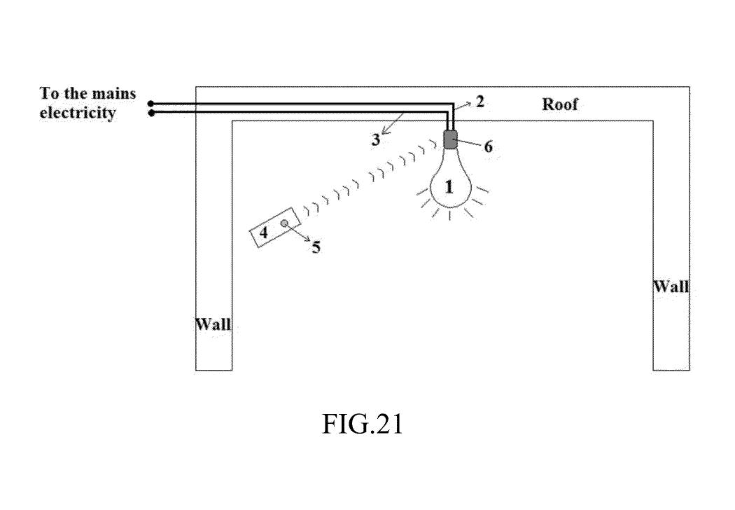

FIG. 21 shows an example embodiment of implementation of the sixth aspect of the invention where it depicts a method to turn ON or OFF a lamp 1 operating with mains electricity which is implemented in the roof of a room. In this example embodiment, a first electronic system 4 is implemented which provides a signal in the form of an ultrasonic wave by pressing the button 5, wherein the said signal is received by a second electrical or electronic system 6, wherein the ON or OFF status of the said lamp 1 is changed if the magnitude of the said received signal is higher than a threshold value. In this example embodiment, the said second electrical or electronic system 6 has a female lamp socket which lamp 1 is connected to. Wires 2 and 3 are connecting the contacts of the said second electrical or electronic system 6 to the mains electricity.

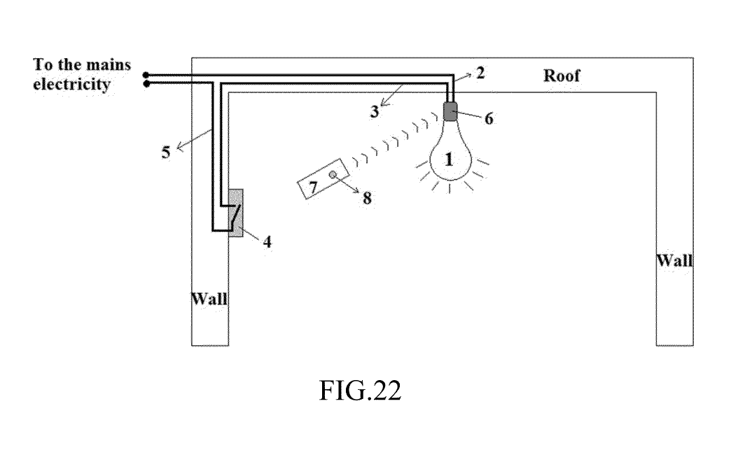

FIG. 22 shows an example embodiment of implementation of the sixth aspect of the invention where it depicts a method to turn ON or OFF a lamp 1 operating with mains electricity which is implemented in the roof of a room. Here, a first electronic system 7 is implemented which provides a signal in the form of an ultrasonic wave by pressing button 8, wherein the said signal is received by a second electrical or electronic system 6, wherein the ON or OFF status of the said lamp 1 is changed if the magnitude of the said received signal is higher than a threshold value and the electrical key 4 is closed in which case wires 5 and 3 are electrically shorted together. Here, lamp 1 is connected to a female lamp socket attached to the said second electrical or electronic system 6, a wire 2 is connecting a first contact of the said second electrical or electronic system 6 to a first contact of the mains electricity, wire 3 is connecting a second contact of the said second electrical or electronic system 6 to a first contact of the electrical key 4, and wire 5 is connecting a second contact of the said key 4 to a second contact of the said mains electricity.

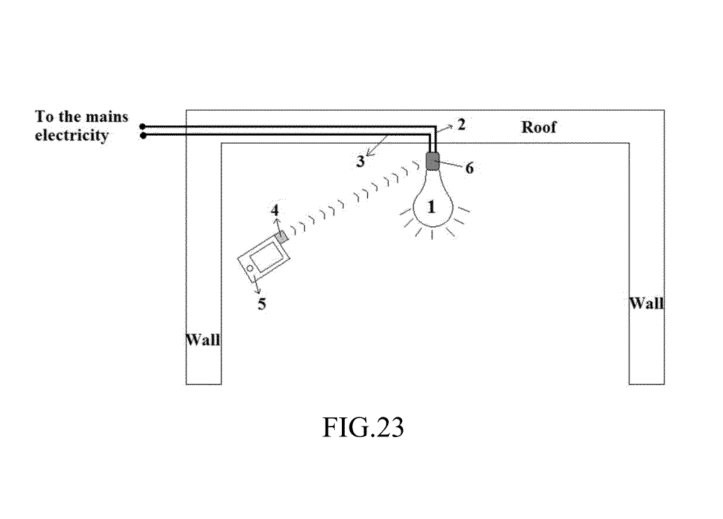

FIG. 23 shows an example embodiment of implementation of the sixth aspect of the invention where it depicts a method to turn ON or OFF a lamp 1 operating with mains electricity which is implemented in the roof of a room. In this example embodiment, a first electronic system 4 is implemented which provides a signal in the form of an ultrasonic wave by pressing a button in a smartphone app in the smartphone 5, wherein the said first electrical or electronic system 4 is in an enclosure attached to the said smartphone 5, wherein the said signal is received by a second electrical or electronic system 6, wherein the ON or OFF status of the said lamp 1 is changed if the magnitude of the said received signal is higher than a threshold value. In this example embodiment, the said second electrical or electronic system 6 has a female lamp socket which lamp 1 is connected to. Wires 2 and 3 are connecting the contacts of the said second electrical or electronic system 6 to the mains electricity.

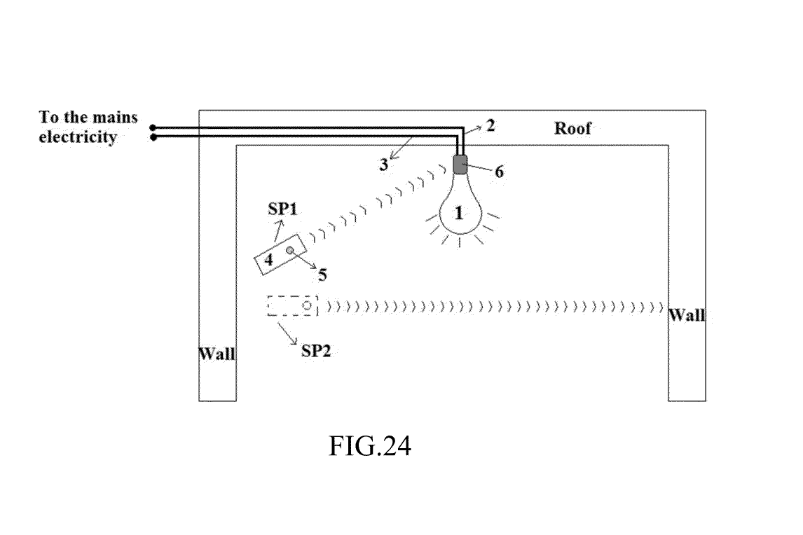

FIG. 24 shows an example embodiment of implementation of the sixth aspect of the invention where it depicts a method to turn ON or OFF a lamp 1 operating with mains electricity which is implemented in the roof of a room. In this example embodiment, a first electronic system 4 is implemented which provides a signal in the form of an ultrasonic wave by pressing the button 5, wherein the said signal is received by a second electrical or electronic system 6, wherein the ON or OFF status of the said lamp 1 is changed if the magnitude of the said received signal is higher than a threshold value. In this example embodiment, the said second electrical or electronic system 6 has a female lamp socket which lamp 1 is connected to. Wires 2 and 3 are connecting the contacts of the said second electrical or electronic system 6 to the mains electricity. Here, the magnitude of the said received signal by the said second electrical or electronic system is changed based on the spatial position of the said first electrical or electronic system, wherein for a first spatial position of the said first electrical or electronic system, SP1, the magnitude of the said received signal is larger than the said threshold value, wherein for a second spatial position of the said first electrical or electronic system, SP2, the magnitude of the said received signal is smaller than the said threshold value, wherein for the said first spatial position SP1, the ON or OFF status of the said light source is changed when button 5 is pressed, wherein for the said second spatial position SP2, the ON or OFF status of the said light source is not changed when button 5 is pressed.

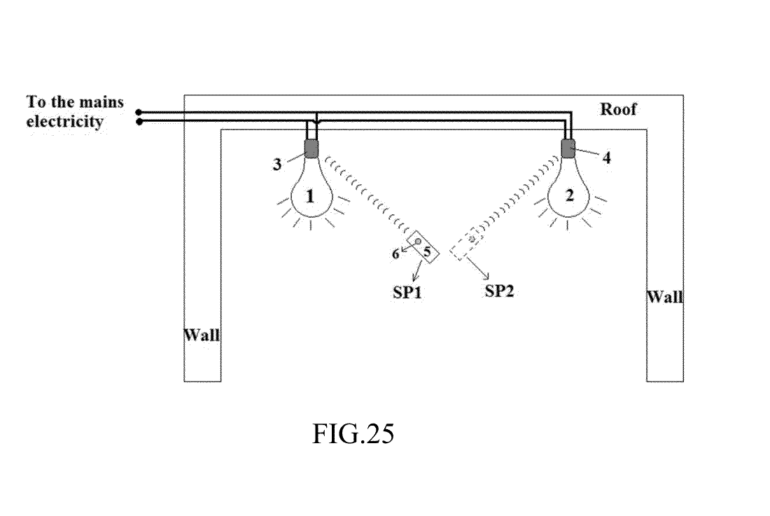

FIG. 25 shows an example embodiment of implementation of the sixth aspect of the invention where it depicts a method to turn ON or OFF two lamps (1 and 2) operating with mains electricity which are implemented in the roof of a room. In this example embodiment, a first electronic system 5 is implemented which provides a signal in the form of an ultrasonic wave by pressing the button 6, wherein the said signal is received by a second or a third electrical or electronic system (3 or 4), wherein the ON or OFF status of the said lamp 1 is changed if the magnitude of the said received signal by the said system 3 is higher than a threshold value, wherein the ON or OFF status of the said lamp 2 is changed if the magnitude of the said received signal by the said system 4 is higher than the said threshold value. Here, the magnitude of the said received signal by the said systems 3 and 4 are changed based on the spatial position of the said system 5, wherein for a first spatial position of the said first electrical or electronic system, SP1, the magnitude of the said received signal by system 3 is larger than the said threshold value and the magnitude of the said received signal by system 4 is smaller than the said threshold value, wherein for a second spatial position of the said first electrical or electronic system, SP2, the magnitude of the said received signal by system 3 is smaller than the said threshold value and the magnitude of the said received signal by system 4 is larger than the said threshold value, wherein for the said first spatial position SP1, the ON or OFF status of lamp 1 is changed when button 6 is pressed and the ON or OFF status of lamp 2 remains unchanged, wherein for the said second spatial position SP2, the ON or OFF status of lamp 2 is changed when button 6 is pressed and the ON or OFF status of lamp 1 remains unchanged.

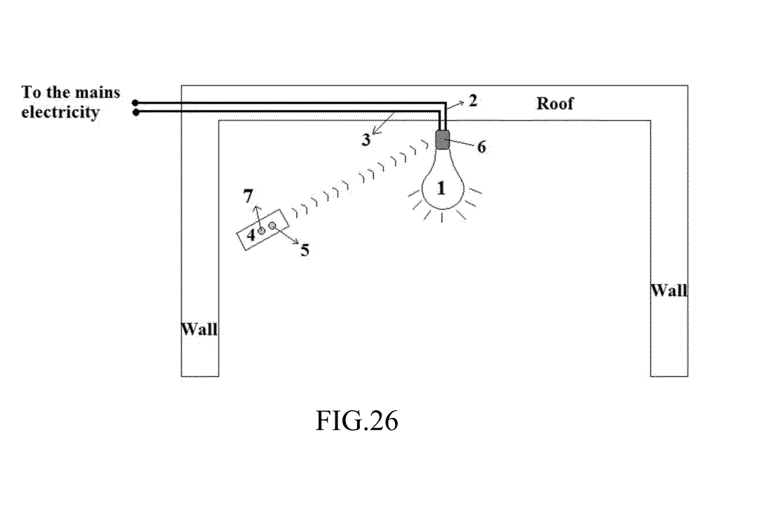

FIG. 26 shows an example embodiment of implementation of the sixth aspect of the invention where it depicts a method to turn ON or OFF a lamp 1 operating with mains electricity which is implemented in the roof of a room. In this example embodiment, a first electronic system 4 is implemented which provides a signal in the form of an ultrasonic wave by pressing button 5 or button 7, wherein the said signal is received by a second electrical or electronic system 6, wherein by pressing button 5, lamp 1 turns ON when the magnitude of the said received signal is higher than the a threshold value, wherein by pressing button 7, lamp 1 turns OFF when the magnitude of the said received signal is higher than the said threshold value. In this example embodiment, the said second electrical or electronic system 6 has a female lamp socket which lamp 1 is connected to. Wires 2 and 3 are connecting the contacts of the said second electrical or electronic system 6 to the mains electricity.

An electrical or electronic device may be fabricated which comprises of the second electrical or electronic system as described in the sixth aspect of the invention, wherein the said device has a male and a female lamp socket, wherein the said male socket has a first electrical terminal, wherein the said female socket has a second electrical terminal, wherein the said first and second electrical terminals will be electrically connected together or the resistance between them is smaller than 10 Ohms when the magnitude of the said received signal is larger than the said threshold value, wherein the said first and second electrical terminals will be electrically disconnected from each other or the resistance between them is larger than 10 Ohms when the magnitude of the said received signal is smaller than the said threshold value. In this case, the said device may be implemented in between a lamp and a typical female lamp socket of a roof of a room in order to implement the sixth aspect of the invention.

1. An electrical or electronic device comprising of a camera, said device has a fixture or fixtures allowing the said device to be attached to a peephole lens or to be mounted on a door through a hole from one side of the said door to its other side, wherein the said hole has a diameter of at least 0.5 cm, wherein the said device sends a live view or a picture captured by the said camera to a second electrical or electronic device, wherein the said live view or picture is displayed in a smartphone, or a tablet or a computer.

2. The second electrical or electronic device as described in claim 1, wherein the said second electrical or electronic device is the said smartphone, or the said tablet, or the said computer.

3. The device of claim 1, wherein the said hole is a hole generated on a door for mounting a peephole lens.

4. The device of claim 1, further comprising of a button or a touch sensor, wherein pressing the said button or touching the said sensor provides a signal to cause a ring, or a beep, or a music, or a vibration, or a noise in the said device that has a camera or another electrical or electronic device.

5. The device of claim 4, wherein pressing the said button or touching the said sensor provides a signal to cause a ring, or a beep, or a music, or a vibration, or a noise in another electrical or electronic device connected to an electrical power outlet of a wall.

6. The device of claim 1, further comprising of a motion detector sensor or a vibration sensor.

7. The device of claim 1, further comprising of a vibration sensor, wherein a vibration of the said device that has a camera provides a signal to cause a ring, or a beep, or a music, or a vibration, or a noise in the said device that has a camera or another electrical or electronic device.

8. A method to provide a live view form back of a car, said method comprises of implementation of a first electrical or electronic device, wherein the said first device comprises of a camera, wherein the said first device sends a live view captured by the said camera to a second electrical or electronic device, wherein the said live view is displayed by a smartphone, or a tablet, wherein at least two lines are displayed by the said smartphone or tablet, wherein an approximate future location of the said car may lie between the said lines, should the said car move backward.

9. The second electrical or electronic device as described in claim 8, wherein the said second device is the said smartphone, or the said tablet.

10. The method of claim 8, wherein the positions of the said lines in the display of the said smartphone or tablet can be adjusted.

11. An electronic device comprising of a laser light source, said device has a first button or touch sensor and a second button or touch sensor, wherein pressing the said button or buttons or touching the said sensor or sensors causes pages of a presentation slide file in an smartphone to turn, wherein by pressing the said first button or touching the said first touch sensor, the current page of the said presentation file is turned to a next page, wherein by pressing the said second button or touching the said second touch sensor, the current page of the said presentation file is turned to a previous page.

12. The electronic device of claim 11, further comprising of a third button or touch sensor, wherein pressing the said third button or touching the said third sensor turns ON the said laser light source.

13. A method to perform a presentation by using the electronic device of claim 11, said method comprises of connecting the said smartphone to a projector or a monitor using an adapter, wherein by pressing the said first button or touching the said first touch sensor, the current page of the said presentation file is turned to a next page, wherein the slides or pages of the said presentation file is displayed on the said monitor or is projected by the said projector.

14. A method to attach a handsfree or an earphone or a USB connector to a smartphone or a smartphone protective cover, said method comprises of physically connecting a cable of the said handsfree or the said earphone or the said USB connector to a part of the said smartphone or cover, wherein a part of the cable of the said handsfree or earphone or USB connector can go inside or come out of the case of the said smartphone or the said cover.

15. The method of claim 14, wherein the said handsfree or earphone or USB connector is attached to a smartphone protective cover, wherein a smartphone is placed inside the said cover, wherein the said cover has an electronic connector or adapter, wherein the said handsfree or earphone or USB connector is electrically or electronically connected to the said smartphone through the said electronic connector or adapter.

16. A method to implement a light source in a cable, or in an electrical or electric connector, or in an electrical or electric adapter, or in a charger, or in an electrical or electronic plug, said method comprises of implementation of a rechargeable electrical or electronic power source, wherein the said power source may provide a power to turn ON the said light source, wherein the said power source may charge up when the said cable, or connector, or adapter, or charger or plug is electrically or electronically connected to another electrical or electronic device, or another cable, or another connector, or another adapter, or another plug or a mains power.

17. The method of claim 16, wherein the said charger is a smartphone charger or a tablet charger.

18. The method of claim 16, wherein the said light source is a Light Emitting Diode.

19. The method of claim 16, wherein the said rechargeable electrical or electronic power source is a capacitor, or a super capacitor or a rechargeable battery.

20. An electronic circuit used to implement the method of claim 16, said circuit has a first and a second and a third and a fourth electrical node, wherein the said first node is electrically connected to an anode of a diode, wherein the said second node is electrically connected to a first electrical terminal of the said power source and a first electrical terminal of a resistor, wherein the said third node is electrically connected a cathode of the said diode and to a second electrical terminal of the said power source and to a first electrical terminal of the said light source, wherein the said fourth node is electrically connected to a second electrical terminal of the said light source and to a second electrical terminal of the said resistor, wherein the said first and second nodes are electrically connected to the wires of the said cable, or to electrical terminals of the said electrical or electric connector, or to electrical terminals of the said electrical or electric adapter, or to electrical terminals of the said charger, or to electrical terminals of the said electrical or electronic plug.

21. A method to turn ON or OFF an electrical light source operating with mains electricity or household electricity, said method comprises of implementation of a first electrical or electronic system that provides a signal in the form of an ultrasonic or an electromagnetic wave, wherein the said signal is received by a second electrical or electronic system, wherein the ON or OFF status of the said light source may be changed if the magnitude of the said received signal is higher than a threshold value.

22. The first electrical or electronic system described in claim 21, further comprising of a button or a touch sensor, wherein pressing the said button or touching the said sensor provides the said signal, wherein by pressing the said button or touching the said sensor, the ON or OFF status of the said light source is changed when the magnitude of the said received signal is higher than the said threshold value.

23. The first electrical or electronic system described in claim 21, further comprising of a first button or a touch sensor and a second button or touch sensor, wherein pressing either of the said button or buttons or touching the said sensor or sensors provides the said signal, wherein by pressing the said first button or touching the said first sensor, the said light source turns ON when the magnitude of the said received signal is higher than the said threshold value, wherein by pressing the said second button or touching the said second sensor, the said light source turns OFF when the magnitude of the said received signal is higher than the said threshold value.

24. The method of claim 21, wherein the magnitude of the said received signal by the said second electrical or electronic system may be changed based on the spatial position of the said first electrical or electronic system, wherein for a first spatial position of the said first electrical or electronic system, the magnitude of the said received signal is larger than the said threshold value, wherein for a second spatial position of the said first electrical or electronic system, the magnitude of the said received signal is smaller than the said threshold value, wherein for the said first spatial position, the ON or OFF status of the said light source may be changed when the said signal is received by the said second electrical or electronic system, wherein for the said second spatial position, the ON or OFF status of the said light source is not changed when the said signal is received by the said second electrical or electronic system.

25. The method of claim 21, wherein the said electrical light source is a lamp, wherein the said second electrical or electronic system is implemented in an enclosure attached to the said lamp, wherein a male lamp socket is attached to the said enclosure.

26. The method of claim 21, wherein the said first electrical or electronic system is in an enclosure attached to a smartphone.

27. An electrical or electronic device comprising of the second electrical or electronic system described in claim 21, wherein the said device has a male and a female lamp socket, wherein the said male socket has a first electrical terminal, wherein the said female socket has a second electrical terminal, wherein the said first and second electrical terminals will be electrically connected together or the resistance between them is smaller than 10 Ohms when the magnitude of the said received signal is larger than the said threshold value, wherein the said first and second electrical terminals will be electrically disconnected from each other or the resistance between them is larger than 10 Ohms when the magnitude of the said received signal is smaller than the said threshold value.
